(19) United States
(12) Patent Application Publication
(10) Pub. No.: US 2011/0030471 A1
(43) Pub. Date: Feb. 10, 2011

(54) OSCILLATION CONTROL DEVICE

(76) Inventor: Teruo MAEDA, Yokohama (JP)

Correspondence Address: WENDEROTH, LIND & PONACK, L.L.P., 1030 15th Street, N.W.,, Suite 400 East, Washington, DC, 20005-1503, US

(21) Appl. No.: 12/537,379

(22) Filed: Aug. 7, 2009

(51) Int. Cl. G01C 19/56

(52) U.S. Cl. 73/504.12

(57) ABSTRACT

An oscillation control device includes a base body, a movable object, an inertial mass and a driving mechanism. The movable object is supported to the base body. The inertial mass is capable of applying inertial force to the movable object. The driving mechanism mechanically connects the base body and the inertial mass with each other so that the driving mechanism can drive the inertial mass according to a relative movement between the movable object and the base body so that the relative movement therebetween can be suppressed due to the inertial force.

### BACKGROUND OF THE INVENTION

1. Field of the Invention

The present invention relates to an oscillation control device in which a relative movement of a movable object can be controlled relative to a base body that supports the movable object.

2. Description of the Related Art

Various kinds of conventional oscillation control devices are known. For example, using springs and dampers disposed between a movable object and a base body. However, this conventional device provides a problem in that it is often difficult to select proper values of the springs and damping factors. When the relative speed therebetween is small, dampers cannot generate sufficient damping forces, so that it is hard to control the relative movement of the movable object, such as the period, the amplitude and the attitude of the oscillation, against the oscillation applied to the movable object and/or the base body.

On the other hand, it is known to use electronics control for changing attitudes of wings provided on both side portion of a vessel's body. However, this conventional device costs high.

It is, therefore, an object of the present invention to provide an oscillation control device which overcomes the foregoing drawbacks and can control the oscillation period of a movable object, which is supported on a base body, to be controlled properly at low costs, suppressing the amplitude of the oscillation.

### SUMMARY OF THE INVENTION

According to a first aspect of the present invention there is provided an oscillation control device including a base body, a movable object, an inertial mass and a driving mechanism. The movable object is supported to the base body. The inertial mass is capable of applying inertial force to the movable object. The driving mechanism mechanically connects the base body and the inertial mass with each other so that the driving mechanism can drive the inertial mass according to a relative movement of the movable object relative to the base body so that the relative movement can be suppressed due to the inertial force.

### BRIEF DESCRIPTION OF THE DRAWINGS

The objects, features and advantages of the present invention will become apparent as the description proceeds when taken in conjunction with the accompanying drawings, in which:

FIG. 1A is a schematic view showing an oscillation control device of a first embodiment according to the present invention in a state where it is maintained at a static position, FIG. 1B is a schematic view showing a state where a relative distance between a movable object and a base body increases beyond a static-position distance due to external force, and FIG. 1C is a schematic view showing a state where the relative vertical distance decreases from the static-position distance due to the external force;

FIG. 2A is a schematic view showing an oscillation control device of a second embodiment according to the present invention at a static position, FIG. 2B is a schematic view showing a state where a movable object is inclined due to external force relative to a base body in a one rotational direction, and FIG. 2C is a schematic view showing a state where the movable object is inclined due to the external force relative to the base body in the other rotational direction;

FIG. 3 is a schematic view showing an oscillation control device of a third embodiment according to the present invention;

FIG. 4 is an enlarged sectional plan view of a driving mechanism used in the oscillation control device of the third embodiment;

FIG. 5 is a schematic view showing an oscillation control device of a fourth embodiment according to the present invention;

FIG. 6 is a side view showing an oscillation control device of a fifth embodiment where the oscillation control device of the first embodiment is applied to a ship;

FIG. 7 is a side view showing an oscillation control device of a sixth embodiment where the oscillation control device of the second embodiment is applied to a ship;

FIG. 8 is a front view showing an oscillation control device of a seventh embodiment where the oscillation control device of the second embodiment is slightly modulated and applied to a ship;

FIG. 9A is a plan view showing an oscillation control device of an eighth embodiment where the oscillation control device of the third embodiment is applied to a ship, and FIG. 9B is a side view, taken along a line X-X in FIG. 9A, showing a front half of the ship shown in FIG. 9A; and

FIG. 10A is a plan view showing an oscillation control device of a ninth embodiment where the oscillation control device of the fourth embodiment is applied to a ship, and FIG. 10B is a side view, taken along a line X-X in FIG. 10A, showing a front half of the ship shown in FIG. 10A.

### DETAILED DESCRIPTION OF THE PREFERRED EMBODIMENTS

Throughout the following detailed description, similar reference characters and numbers refer to similar elements in all figures of the drawings, and their descriptions are omitted for eliminating duplication.

The following first to fourth embodiments will be explained as two-dimensional models for easy understanding, although they are actually three-dimensional models.

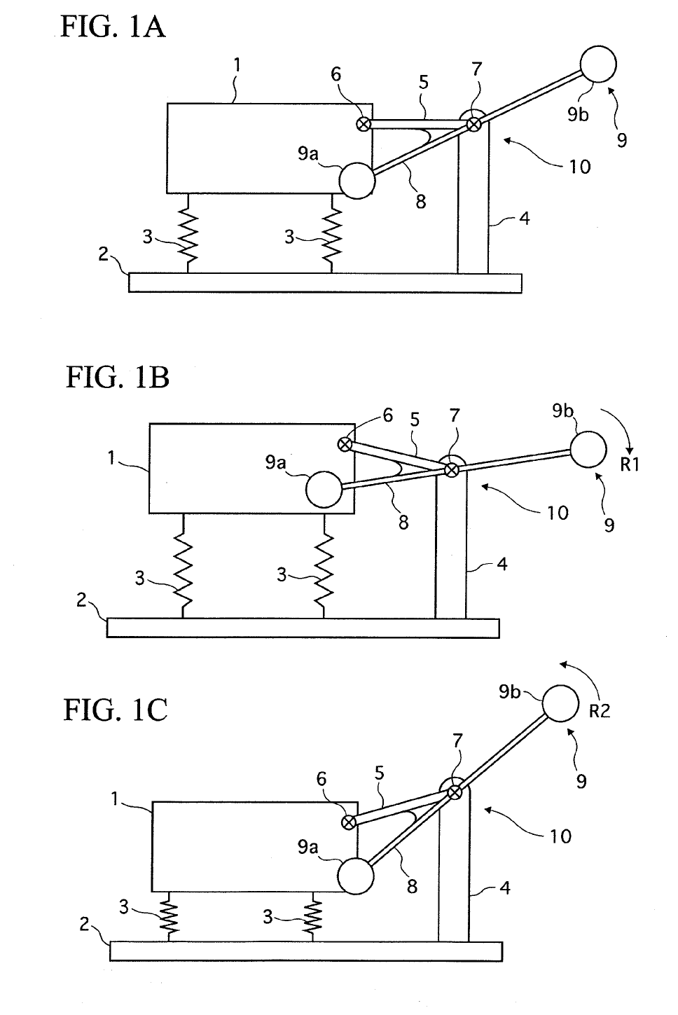

Referring to FIGS. 1A to 1C of the drawings, there is shown an oscillation control device of a first preferred embodiment according to the present invention.

The oscillation control device of the first embodiment includes a movable object 1, a base body 2, a plurality of springs 3, an inertial mass 9 and a driving mechanism 10.

The base body 2 is placed on the ground, the water, buildings or the like, and it is constructed so as to move together with a movement thereof relative thereto.

The springs 3 are arranged apart from each other, fixing the movable object 1 and the base body 2 with each other so that the movable object 1 can be elastically supported over the base body 2 to move relative to the base body 2.

The base body 2 is fixed at one end portion thereof with a pillar 4, which extends upward from an upper surface of the base body 2. The pillar 4 is provided with a first pivot 7 at its top portion. A connecting link 5 is connected with the first pivot 7 at its one end portion and with a second pivot 6 at its other end portion. The second pivot 6 is provided at one side portion of the movable object 1, so that the movable object 1 is swingable around the first pivot 7, relative to the base body 2. The connecting member 5 corresponds to a link member of the present invention.

The connecting link 5 is integrally connected with a beam 8, being swingable around the first pivot 7 together with the beam 8. The beam 8 is provided with a first inertial mass 9a and a second inertial mass 9b at both end portions thereof, respectively. The first inertial mass 9a and the second inertial mass 9b constitute the inertial mass 9, and they have the same weight, being apart the equivalent distance from the first pivot 7 in this embodiment. Accordingly, the first and second masses 9a and 9b themselves do not apply their swinging torque to the springs 3 when the oscillation device is at a static position.

FIG. 1A shows a state where the movable object 1 is at the static position where it is maintained horizontally and stably when the base body 2 is placed horizontally in a state where no external force acts on the movable object 1 and the base body 2 for long time.

The movable object 1 moves up and down to oscillate vertically as follows when external forces acts on the base body 2.

When the external force acts on the base body 2 to extend both of the springs 3 so that the movable object 1 moves to increase a relative vertical distance between the movable object 1 and the base pate 2 as shown in FIG. 1B, the connecting link 5 swings in a clockwise direction R1 in FIG. 1B around the first pivot 7. This clockwise directional movement of the connecting kink 5 causes the beam 8 to swing together with the first and second inertial masses 9a and 9b around the first pivot 7 in the clockwise direction R1. Therefore, inertial force due to the swinging movement of the first and second inertial masses 9a and 9b acts on the springs 3 to suppress the upward movement of the springs 3 and the movable object 1 through the beam 8, the connecting link 5, the second pivot 6 and the movable object 1.

On the other hand, when the external force acts on the base body 2 to contract the both of springs 3 so that the movable object 1 moves to decrease the relative vertical distance between the movable object 1 and the base body 2 as shown in FIG. 1C, the connecting link 5 swings in a counterclockwise direction R2 in FIG. 1C around the first pivot 7. This counterclockwise directional movement of the connecting link 5 causes the beam 8 to swing together with the first and second masses 9a and 9b around the first pivot 7 in the counterclockwise direction R2. Therefore, the inertial force due to the swinging movement of the first and second inertial masses 9a and 9b acts on the springs 3 to suppress the downward movement of the springs 3 and the movable object 1 through the beam 8, the connecting link 5, the second pivot 6 and the movable object 1.

When the movable object 1 is inclined due to the external force acting on the base body 2, the connecting link 5 swings according to an inclined state of the movable object 1, so that the inertial force due to the swinging movement of the first and second inertial masses 9a and 9b acts on the springs 3 to suppress the declining movement of the movable object 1, as understood from the above-described explanation.

In this oscillation, the inertial force of the inertial mass 9 suppresses the amplitude of the oscillation and causes the oscillation period to be properly longer.

The oscillation period can be controlled by choosing the values of the inertial masses 9 and the ratio of the relative movement between the movable object 1 and the base body 2 and the movement of the inertial masses 9.

The oscillation control device of the first device can suppress the relative movement of the movable object 1 relative to the base body 2 easily and at low cost by using the inertial force due to the swinging movement of the inertial masses 9, thus providing comfort ride.

Next, an oscillation control device of a second embodiment according to the present invention will be described with the accompanying drawings.

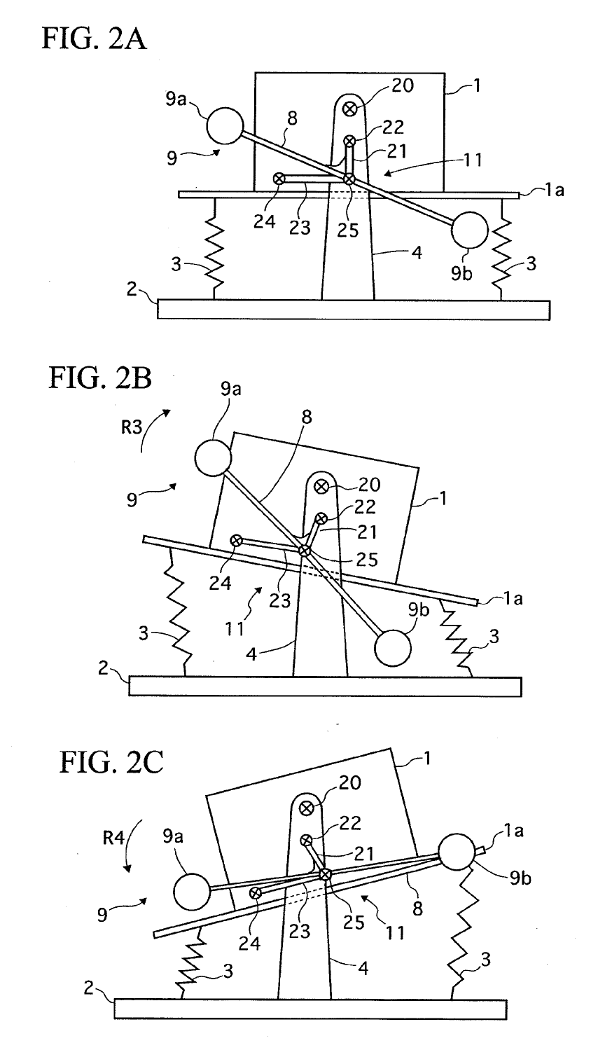

As shown in FIG. 2A, in the oscillation control device of the second embodiment, a pillar 4 is fixed on a base body 2 at an intermediate portion of the base body 2 to extend upward from its upper surface. The pillar 4 is provided with a third pivot 20 at its top portion and with a fourth pivot 22 under the third pivot 20. The third pivot 20 swingably supports a movable object 1 to the pillar 4.

A driving mechanism 11 of the second embodiment includes the fourth pivot 22, a fifth pivot 24, a sixth pivot 25, a first swingable link 21 and a second swingable link 23. The first and second swingable links 21 and 23 correspond to first and second link members of the present invention, respectively.

The first swingable link 21 is connected with the fourth pivot 22 at its one end portion and with the sixth pivot 25 at its other end portion. The second swingable link 23 is connected with the movable object 1 through the fifth pivot 24 at its one end portion and with the other end portion of the first swingable link 21 through the sixth pivot 25 at its other end portion. Thus, the first and second swingable links 21 and 23 form like an L-letter shape and move relative to each other. The first swingable link 21 is integrally connected with a beam 8, both end portions of which are provided with a first inertial mass 9a and a second inertial mass 9b, respectively.

The movable object 1 has an extended bottom portion 1a that extends outward from a periphery of a bottom portion of the movable object 1. The springs 3 are arranged apart from each other, being fixed on the extended bottom portion 1a and the base body 2.

The other parts and portions are constructed similarly to those of the first embodiment.

In the oscillation control device of the second embodiment, the movable objects 1 and others move as follows when external force acts on the base body 2 to oscillate. FIG. 2A shows the oscillation control device of the second embodiment at a static position.

As shown in FIG. 2B, when the external force acts on the base body 2 and the movable object 1 is inclined relative to the base body 2 around the third pivot 20 in a clockwise direction R3 so that the left side spring 3 extends and the right side spring 3 contracts, the first swingable link 21 rotates around the fourth pivot 22 in the clockwise direction R3 and the fifth pivot 24 moves in a left direction from the static position. This movement of the links 21 and 23 causes the beam 8 to be rotated in the clockwise direction R3, thus the inertial masses 9a and 9b applying inertial force to the movable object 1 and the springs 3 in a counterclockwise direction to suppress the inclination movement of the movable object 1.

On the other hand, as shown in FIG. 2C, when the external force acts on the base body 2 and the movable object 1 is inclined relative to the base body 2 around the third pivot 20 in the counterclockwise direction R4 so that the left side spring 3 contracts and the right side spring 3 extends, the first swingable link 21 rotates around the fourth pivot 22 in the counterclockwise direction R4 and the fifth pivot 24 moves in a right direction from the static position. This movement causes the beam 8 to be rotated in the counterclockwise direction R4, thus the inertial masses 9a and 9b applying their inertial forces to the movable object 1 relative to the base body 2 in the clockwise direction to suppress the inclination movement of the movable object 1.

Similarly, a heaving oscillation can be suppressed by the oscillation control device of the second embodiment.

Therefore, in this oscillation, the inertial force of the inertial mass 9 suppresses the amplitude of the oscillation and causes the oscillation period to be properly longer. In addition, the rotational speed of the beam 8 is increased relative to that of the movable object 1 by a lever ratio that is determined by positions of the third pivot 20, the fourth pivot 22 and the sixth pivot 25. Accordingly, the inertial force is also increased due to increased rotational speed determined according to the lever ratio. This enables the inertial masses 9a and 9b to be smaller in order to obtain the same amplitude of the inertial force.

As understood above, the oscillation control device of the second device can suppress the relative movement of the movable object 1 relative to the base body 2 easily and at low cost by using the inertial force due to the swinging movement of the inertial masses 9 similarly to those of the first embodiment.

Next, an oscillation control device of a third embodiment according to the present invention will be described with the accompanying drawings.

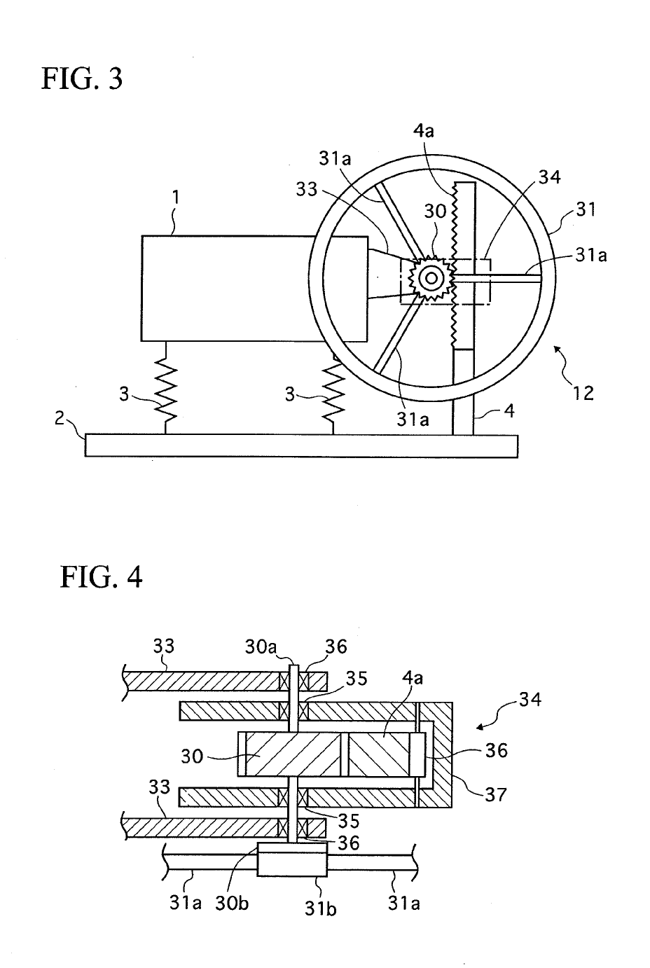

FIG. 3 illustrates the oscillation control device of the third embodiment, eliminating some parts of a driving mechanism thereof in order to facilitate visualization thereof, while FIG. 4 shows an enlarged cross sectional plan view of a detail construction of the driving mechanism.

As shown in FIG. 3 and FIG. 4, in the oscillation control device of the third embodiment, the first and second inertial mass 9a and 9b and the beam 8 of the first and second embodiments are replaced by a wheel 31 with three spokes 31a and a hub portion 31b. The hub portion 31b is fixed to a hub portion 30b of a pinion 30, which will be later explained. The spokes 31a may be replaced by a disc portion connecting the hub portion 31b and the wheel 31.

A pillar 4 is fixed on one end portion of a base body 2, being formed with a rack portion 4a at an upper portion thereof. The rack portion 4a engages with the pinion 30, a shaft 30a of which is rotatably supported by a U-shaped bracket 33 through bearings 36. The bracket 33 is fixed on one side portion of a movable object 1.

As shown in FIG. 4, a retainer 34 is formed like a U shape to support the shaft 30a of the pinion 30 inside the bracket 33 through bearings 35. The retainer 34 is provided with a roller 36 that contacts with a rear surface of the rack portion 4a so as to always keep engagement of the pinion 30 and the rack portion 4a.

The shaft 30a of the pinion 30 is provided with the hub portion 30b at a wheel 31 side, and the hub portion 30b is fixed with the hub portion 31b of the wheel 31 by using not-shown bolts.

The other parts and portions of the third embodiment are constructed similarly to those of the first embodiment.

When external force does not act on the movable object 1 and the base body 2, they are kept horizontally at a static position as shown in FIG. 3.

When the external force acts on the base body 2 to move pinion 30 upward along the teeth of the rack portion 4a in an inclined attitude or a horizontally-maintained attitude, deforming the left and right side spring 3, the pinion 30 is rotated in a clockwise direction. The rotation of the pinion 30 causes the wheel 31 to also rotate in the clockwise direction through the shaft 30a, the hub portion 30b, the hub portion 31b and the spokes 31a. Consequently, the wheel 31 applies its inertial force to the pinion 30 so as to move it downward, suppressing the clockwise directional and/or upward movement of the movable object 1.

On the other hand, when the external force acts on the base body 2 to move the pinion 30 downward along the teeth of the rack portion 4a in an inclined attitude or the horizontally-maintained attitude, deforming the left and right side spring 3, the pinion 30 is rotated in a counterclockwise direction. The rotation of the pinion 30 causes the wheel 31 to rotate in the counterclockwise direction. Consequently, the wheel 31 applies its inertial force to the pinion 30 in the clockwise direction so as to move the pinion 30 upward, suppressing the counterclockwise directional and/or downward movement of the movable object 1.

As understood from the above-described explanation, the oscillation control device of the third embodiment can suppress the amplitude of the oscillation, controlling the oscillation period to be proper easily and at low costs.

Next, an oscillation control device of a fourth embodiment according to the present invention will be described with the accompanying drawings.

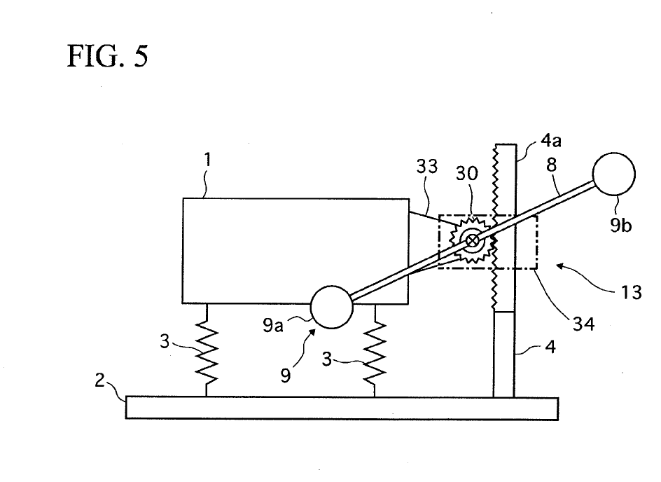

FIG. 5 shows the oscillation control device of the fourth embodiment at a static position.

In the oscillation control device of the fourth embodiment, the wheel 31 of the third embodiment is replaced by a first inertial mass 9a and a second inertial mass 9b that are connected with each other by a beam 8.

The other parts and portions of the fourth embodiment are constructed similarly to those of the third embodiment.

Accordingly, the operation of the fourth embodiment is similar to that of the third embodiment, and the advantages of the fourth embodiment are also similar to those of the third embodiment.

Next, an oscillation control device of a fifth embodiment where the oscillation control device of the first embodiment is applied to a ship will be described with the accompanying drawing.

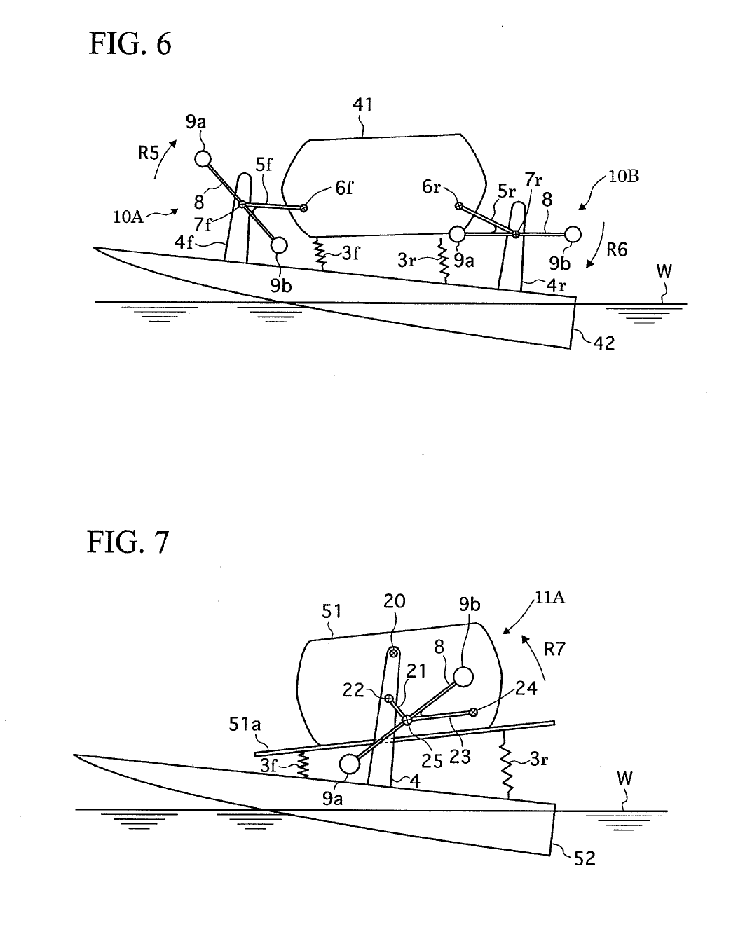

Referring to FIG. 6, in the oscillation control device of the fifth embodiment, the movable object 1 of the first embodiment is constructed by a cabin 41 and the base body 2 of the first embodiment is constructed by a float 42 that is capable of floating on the water W. The cabin 41 is supported on the float 42 by using a front side spring 3f and a rear side spring 3r.

A front driving mechanism 10A and a rear driving mechanism 10B are constructed similarly to the driving mechanism 10 of the first embodiment.

A front pillar 4f and a rear pillar 4r are fixed on front and rear portions of the float 42 to extend upward therefrom, respectively.

A front connecting link 5 connects a front portion of the cabin 41 and the front pillar 4f through pivots 6f and 7f. The pivot 6f is provided on a front portion of the cabin 42, and the pivot 7f is provided on upper portion of the front pillar 4f, respectively. The front connecting link 5f is integrally connected with a front beam 8 that has inertial masses 9a and 9b at both end portions thereof, so that inertial masses 9a and 9b can rotate around the pivot 7f.

Similarly, a rear connecting link 5r connects a rear portion of the cabin 41 and the rear pillar 4r through pivots 6r and 7r. The pivot 6r is provided on a rear portion of the cabin 42, and the pivot 7r is provided on upper portion of the rear pillar 4r, respectively. The rear connecting link 5 is integrally connected with a rear beam 8 that has inertial masses 9a and 9b at both end portions thereof, so that inertial masses 9a and 9b can rotate around the pivot 7r.

The operation of the oscillation control device of fifth embodiment will be described.

FIG. 6 shows a state where the cabin 41 is in a pitching oscillation when external force from the water W acts on the float 42.

In this pitching oscillation, when the cabin 41 rotates relative to the float 42, due to external force applied from the water W, in a counterclockwise direction so that the front side spring 3f contracts and the rear side spring 3r extends as shown in FIG. 6, the front side first and second inertial masses 9a and 9b are rotated in a clockwise direction R5, and the rear side first and second inertial masses 9a and 9b are also rotated in the clockwise direction R6.

In this case, inertial forces due to rotational movements of the front and rear inertial masses 9a and 9b act on front and rear connecting links 5f and 5r so as to turn the cabin 41 relative to the float 42 in the clockwise direction to return to a static position.

On the other hand, when the external forces act on the float 42 in the clockwise direction, the inertial masses 9a and 9b are rotated in the counterclockwise direction. Consequently, the inertial forces of the inertial masses 9a and 9b act on the front and rear connecting links 5f and 5r so as to turn the cabin 41 relative to the float 42 in the counterclockwise direction to return to the static position.

Incidentally, the inertial force acts on the cabin 41 to approach the float 42 when external force move them to be away from each other, while the inertial force acts on the cabin 41 to move away from the float 42 when external force moves them toward each other. In these both cases where they approach or move away, the cabin 41 can move relative to the float 42, being kept substantially in a horizontal attitude and parallel to the float 42.

Therefore, the cabin 41 is maintained at the static position as possible, against the heaving and pitching oscillation due to the external forces.

As understood from above-described explanation, in the oscillation control device as the ship of the fifth embodiment, the amplitude of the heaving and pitching oscillation of the cabin 41 is suppressed, and the oscillation period thereof becomes longer to be controlled properly, bringing comfortable ride and stability of the ship.

Next, an oscillation control device of a sixth embodiment where the oscillation control device of the second embodiment is applied to a ship will be described with the accompanying drawing.

As shown in FIG. 7, the ship of the sixth embodiment has a float 52. A cabin 51 is elastically mounted on the float 52 through springs 3f and 3r that are connected with an extended bottom portion 51 a of the cabin 51 and upper faces of the float 52. The float 52 corresponds to the base body of the present invention.

A pillar 4 is fixed on the float 52 at a central portion thereof to extent upward therefrom. The float 52 is provided with a driving mechanism 11A similar to that of the second embodiment.

A pivot 20 is provided on a top portion of the pillar 4 to swingably support the cabin 51 around the pivots 20. The pillar 4 has a pivot 22 under the pivot 20 to rotatably support a first swingable link 21. A rear side lower portion of the cabin 51 has a pivot 24 to rotatably support a second swingable link 23. The fist swingable link 21 and the second swingable link 23 are connected with each other by a pivot 25, and a center portion of a beam 8 is integrally connected with the second swingable link 23 to move together by the same angle. The beam 8 has a first inertial mass 9a and a second inertial mass 9b at both end portions thereof, respectively.

The operation of the oscillation control device of sixth embodiment will be described.

FIG. 7 shows a state where the cabin 51 is in a heaving and pitching oscillation when external force from the water W acts on the float 52.

In this pitching oscillation, when the cabin 51 rotates relative to the float 52 in a counterclockwise direction so that the front side and rear side springs 3f and 3r deform as shown in FIG. 7, the first and second inertial masses 9a and 9b are also rotated in the counterclockwise direction R7.

In this case, inertial force due to a rotational movement of the inertial masses 9a and 9b acts on the second swingable link 23 so as to turn the cabin 51 relative to the float 52 in a clockwise direction to return the cabin 51 to a static position.

On the other hand, when the cabin 51 rotates relative to the float 52 in the clockwise direction, the inertial masses 9a and 9b are also rotated in the clockwise direction. Consequently, the inertial forces of the inertial masses 9a and 9b act on the second swingable link 23 so as to turn the cabin 51 relative to the float 52 in the counterclockwise direction to return the cabin 51 to the static position.

Incidentally, the inertial force acts on the cabin 51 to approach the float 52 when external force move them to be away from each other, while the inertial force acts on the cabin 51 to move away from the float 52 when external force moves them toward each other. In these both cases where they approach or move away, the cabin 51 can move relative to the float 42, being kept substantially in a horizontal attitude and parallel to the float 52.

Therefore, the cabin 51 is maintained at the static position as possible, against the heaving and pitching oscillation due to the external forces.

As understood from above-described explanation, in the oscillation control device, constructed as the ship, of the fifth embodiment, the amplitude of the heaving and pitching oscillation of the cabin 51 is suppressed and the period thereof becomes longer to be controlled properly, bringing comfortable ride and stability of the ship.

Next, an oscillation control device of a seventh embodiment where the oscillation control device of the second embodiment is slightly modified and applied to a ship will be described with the accompanying drawing.

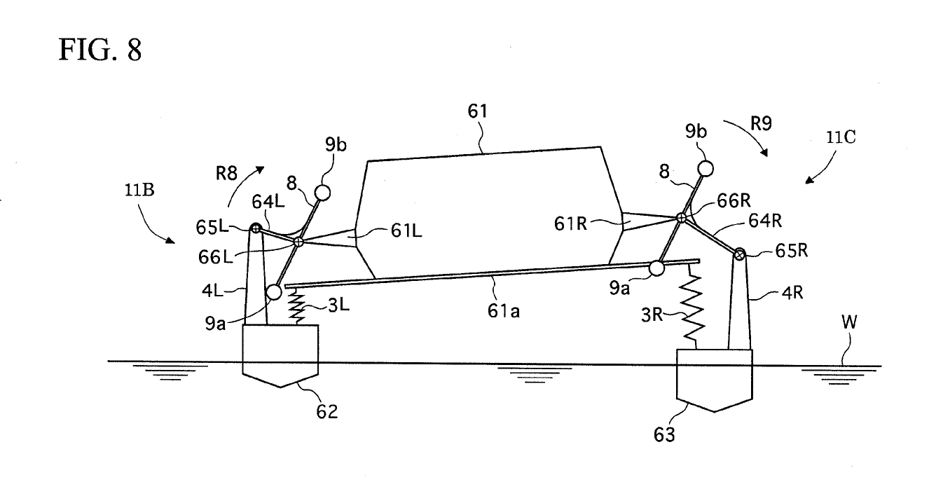

As shown in FIG. 8, the ship of the seventh embodiment has a pair of floats 62 and 63, which are arranged parallel to each other. The floats 62 and 63 correspond to the base body of the present invention and have a left driving mechanism 11B and a right driving mechanism 11C, respectively, which are constructed as follows.

A pair of pillars 4L and 4R are fixed on the floats 62 and 63 to extend upward, respectively. The left and right pillars 4L and 4R are provided with pivots 65L and 65R for supporting swingable links 64L and 64R that extend in a lateral direction of the ship, respectively.

The swingable links 64L and 64R are rotatably connected with left and right brackets 61L and 61R of the cabin 61, being integrally coupled with beams 8, respectively. The left bracket 61L is fixed on a left side surface of the cabin 61. Each of the beams 8 is provided with a first inertial mass 9a and a second inertial mass 9b.

The cabin 61 has an extended bottom portion 61a at a bottom thereof. Two left springs 3L are arranged in a longitudinal direction of the ship, being disposed between a left side portion of the extended bottom portion, and two right springs 3R are arranged in the longitudinal direction, being disposed between a right side portion of the extended bottom portion 61a.

The operation of the oscillation control device of seventh embodiment will be described.

FIG. 8 shows a state where the cabin 61 is in a rolling oscillation when external force from the water W acts on the floats 62 and 63.

In the rolling oscillation, when the cabin 61 rotates relative to the floats 62 and 63 in a counterclockwise direction, the left and right side springs 3L and 3R deform as shown in FIG. 8, the first and second inertial masses 9a and 9b are rotated in a clockwise direction R8 and R9.

In this case, inertial forces due to rotational movements of the inertial masses 9a and 9b act on the swingable links 64L and 64R in a counterclockwise direction. Consequently, the inertial forces act on the left and right brackets 61L and 61R so that the brackets 61L and 61R can be rotated to turn the cabin 61 relative to the floats 62 and 63 in the clockwise direction to return it to a static position.

On the other hand, when the cabin 61 rotates relative to the floats 62 and 63 in the clockwise direction, the inertial masses 9a and 9b are rotated in the counterclockwise direction. Consequently, the inertial forces of the inertial masses 9a and 9b act on the swingable links 64L and 64R to be rotated in the clockwise direction. The inertial forces also act on the brackets 61L and 61R so as to turn the cabin 61 relative to the floats 62 and 63 in the counterclockwise direction to return it to the static position.

Incidentally, the inertial force acts on the cabin 61 to approach the float 62 when external force move them to be away from each other, while the inertial force acts on the cabin 61 to move away from the float 62 when external force moves them toward each other. In these both cases where they approach or move away, the cabin 61 can move relative to the float 42, being kept substantially in a horizontal attitude and parallel to the float 62.

Therefore, the cabin 61 is maintained at the static position as possible, against the heaving and rolling oscillation due to the external forces.

As understood from above-described explanation, in the oscillation control device as the ship of the seventh embodiment, the amplitude of the heaving and rolling oscillation of the cabin 61 is suppressed and the period thereof becomes longer to be controlled properly, bringing comfortable ride and stability of the ship.

Next, an oscillation control device of an eighth embodiment where the oscillation control device of the third embodiment is applied to a ship will be described with the accompanying drawing.

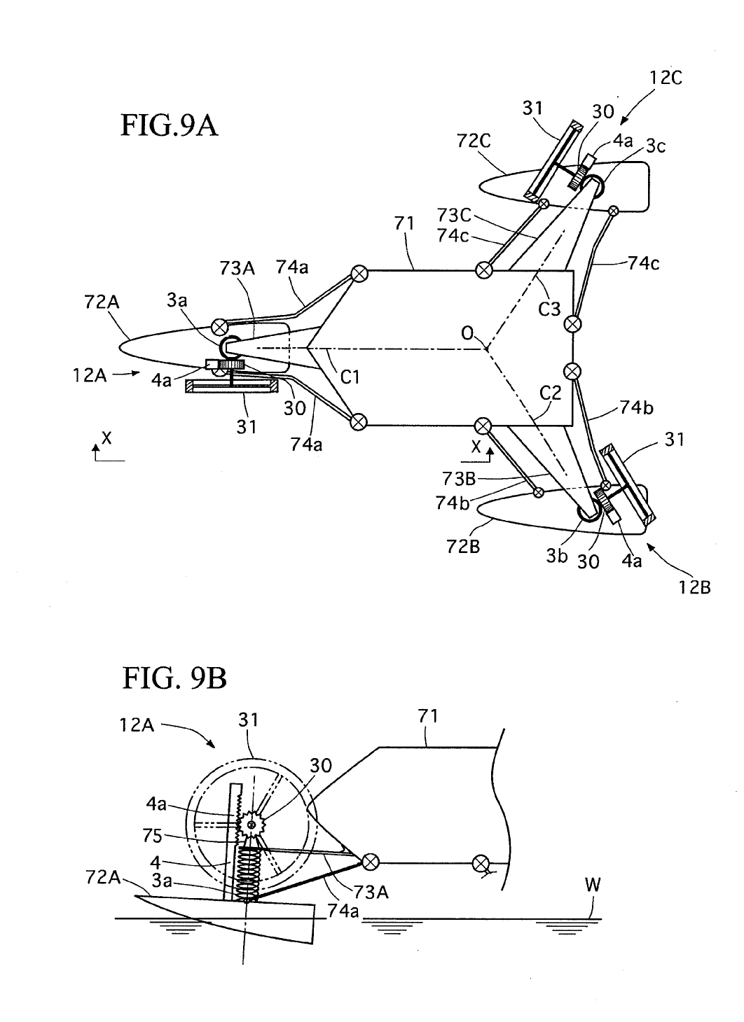

As shown in FIGS. 9A and 9B, the ship of the eighth embodiment has three floats 72A, 72B and 72C that are arranged parallel to one another and located at apexes of a triangle in a plain view. The floats 72A, 72B and 72C correspond to the base body of the present invention and have a first driving mechanism 12A, a second driving mechanism 12B and a third driving mechanism 12C, respectively. The directions of the first to third driving mechanisms 12A to 12C are different from one another to control heaving, pitching and rolling oscillations of a cabin 71, which will later be explained.

The first to third floats 72A to 72C are connected with a bottom portion of the cabin 71 at a front side, a rear left side and a rear right side thereof through connecting links 74a, 74b, 74c and pivots, respectively. The cabin 71 is fixed with the floats 72A, 72B and 72C at the front side, the rear left side and the rear right side thereof by using first to third brackets 73A to 73C, respectively.

From the cabin 71, the first bracket 73A extends forward, the second bracket 73B extends obliquely left backward, and the third bracket 73C extends obliquely right backward. The first connecting links 74a extend forward, the second connecting links 74b extend obliquely left backward, and the third connecting links 74c extend obliquely right backward, so that the first to third floats 72A to 72C can swing upward and downward relative to the cabin 71, not substantially changing their directions.

First to third springs 3a to 3c are disposed between one end portions, opposite to the cabin 71 side, of the first to third brackets 73A to 73C and the first to third floats 72A to 72C, respectively. The first to third brackets 73A to 73C have supporting portions with not-shown bearings for rotatably supporting pinions 30, respectively.

The first to third floats 72A to 72C are fixed with first to third pillars 4 to extend upward therefrom, respectively. The pillars 4 are formed at top portions thereof with rack portions 4a with which the pinions 30 are engaged. The pinions 30 are fixed with wheels 31 functioning as an inertial mass. Incidentally, retainers are provided at the pinions 30 and the rack portions 4a for ensuring engagement thereof, but they are omitted in FIG. 9B for facilitating visualization.

The wheels 31 are arranged so that all of radial directions of the wheels 31 on a plan view of FIG. 9A can pass through or near a center point O, where the center point O is one at which a first center line C1 of the first bracket 73A, a second center line C2 of the second bracket 73B and a third center line C3 intersect with one another.

Therefore, the oscillation control device of the eighth embodiment can properly control the period of the heaving, pitching and rolling oscillations of the cabin 71, suppressing the amplitudes of the oscillations to be the small amounts to keep the cabin 71 at or near the static position of the cabin 71.

Next, an oscillation control device of a ninth embodiment where the oscillation control device of the fourth embodiment is applied to a ship will be described with the accompanying drawing.

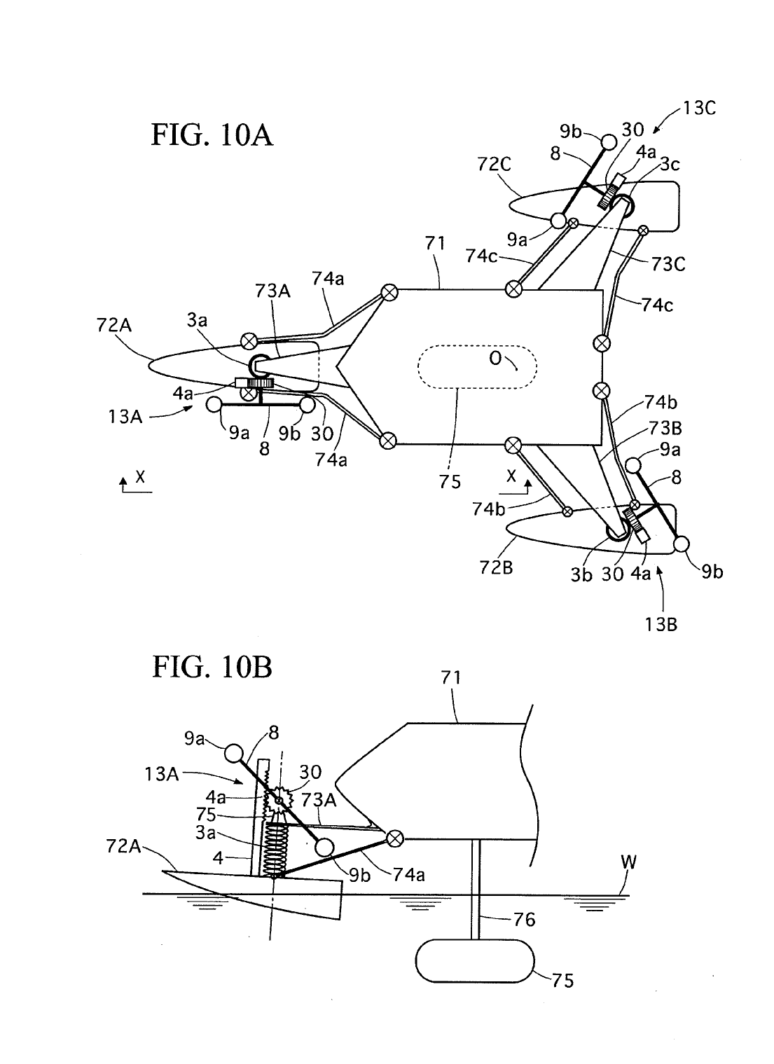

As shown in FIGS. 10A and 10B, in the ninth embodiment, the wheels 31 are replaced by first inertial masses 9a and second inertial masses 9b that are connected by beams 8. In addition, a cabin 71 is provided with a submerged buoyancy body 75 that is connected with the bottom of the cabin 71 through a stem 76. The submerged buoyancy body 75 supports most of the weight of the cabin 71, and a partial weight thereof is supported by the springs 3a to 3c. The submerged buoyancy body 75 and the stem 76 may be eliminated in the ninth embodiment, while it may be added to the cabin 71 of the eighth embodiment.

The other parts and portions are constructed similarly to those of the eighth embodiment.

The operation and the advantages of the oscillation control device of the ninth embodiment are similar to those of the eighth embodiment.

While there have been particularly shown and described with reference to preferred embodiments thereof, it will be understood that various modifications may be made therein, and it is intended to cover in the appended claims all such modifications as fall within the true spirit and scope of the invention.

Incidentally, although the movable object 1 is supported to the base body 2 by using the springs 3 in the above-described embodiments, the springs 3 may be removed so that the movable object 1 can be movably supported on the base body 2 only by using the inertial mass 9 that applies weight and inertial force thereof. In this case, the inertia mass 9 applies the weight thereof to balance with the weight of the movable object 1 in the embodiments. In other words, the springs 3 are not indispensable in the present invention.

When using the springs, the number and arrangement of the springs may be set appropriately.

The configurations and the number of inertial masses may be appropriately set. A beam of the inertial mass may be set to have different lengths from the pivot to the inertial masses 9a and 9b. The inertial mass may be one and is provided at one end portion of a beam that is pivoted at the other end portion.

The number of the driving mechanisms may be changed appropriately.

The movable object is located over the base body in the embodiments, but the movable object may be arranged under the base body by slight modifications.

The applications of the oscillation control device of the present invention are not limited to a water vehicle such as a ship, and the devices of the invention can be applied to various fields such as buildings and the likes. When the invention is applied to ships, the movable object 1 may be a cabin, a steering house, a luggage compartment and the like.

What is claimed is:

1. An oscillation control device comprising:
a base body;
a movable object;
an inertial mass that is capable of applying inertial force to the springs; and
a driving mechanism that mechanically connects the base body and the inertial mass with each other, the driving mechanism being capable of driving the inertial mass according to a relative movement between the movable object and the base body so that the relative movement can be suppressed due to the inertial force.

2. The oscillation control device according to claim 1, wherein
the driving mechanism has a pillar that is connected with the base body, and a link member that is pivotably connected with the movable object at one end portion of the link member and is pivotably connected with the pillar at the other end portion of the link member, and wherein
the link member is connected with the inertial mass so that the inertial mass can move around a pivot through which the end portion of the link member is connected with the pillar.

3. The oscillation control device according to claim 2, further comprising:
a plurality of springs that connect the movable object and the base body with each other to elastically support the movable object so that the movable object can move relative to the base body.

4. The oscillation control device according to claim 2, wherein
the inertial mass is a wheel that is connected with the link member.

5. The oscillation control device according to claim 2, wherein
the inertial mass is a weight block with a beam that is connected with the link member.

6. The oscillation control device according to claim 2, wherein
the base body is a hull of a water vehicle, and wherein
the movable object is at least one of a cabin and a luggage compartment.

7. The oscillation control device according to claim 1, wherein
the driving mechanism has a pillar that is connected with the base body to extend from the base body in the direction, a first link member that is pivotably connected with the pillar at one end portion of the first link member and has a connecting pivot at the other end portion of the first link member, and a second link member that is pivotably connected with the movable object at one end portion of the second link member and is connected with the first link member through the connecting pivot at the other end portion of the second link member, wherein
the movable object is swingably connected with the pillar; and wherein
the inertial mass is connected with one of the first link member and the second link member so as to move according to a movement of the one of the first link member and the second link member.

8. The oscillation control device according to claim 7, further comprising:
a plurality of springs that connect the movable object and the base body with each other to elastically support the movable object so that the movable object can move relative to the base body.

9. The oscillation control device according to claim 7, wherein
the inertial mass is a wheel that is connected with the one of the first swing member and the second swing member.

10. The oscillation control device according to claim 7, wherein
the inertial mass is a weight block with a beam that is connected with the one of the first swing member and the second swing member.

11. The oscillation control device according to claim 7, wherein
the base body is a hull of a water vehicle, and wherein
the movable object is at least one of a cabin and a luggage compartment.

12. The oscillation control device according to claim 1, wherein
the driving mechanism has a pillar connected with the base body, the pillar being provide with a rack portion, a pinion that is connected with the movable object to rotate according to a movement of the movable object and is engaged with the rack portion, and a retainer for maintaining engagement between the rack portion and the pinion, and wherein
the inertial mass is connected with the pinion so as to move according to a rotational movement of the pinion.

13. The oscillation control device according to claim 12, further comprising:
a plurality of springs that connect the movable object and the base body with each other to elastically support the movable object so that the movable object can move relative to the base body.

14. The oscillation control device according to claim 12, wherein
the inertial mass is a wheel that is connected with the pinion.

15. The oscillation control device according to claim 12, wherein
the inertial mass is a weight block with a beam that is connected with the pinion.

16. The oscillation control device according to claim 12, wherein
the base body is a hull of a water vehicle, and wherein
the movable object is at least one of a cabin and a luggage compartment.

17. The oscillation control device according to claim 1, further comprising:
a plurality of springs that connect the movable object and the base body with each other to elastically support the movable object so that the movable object can move relative to the base body.

18. The oscillation control device according to claim 1, wherein
the inertial mass is a wheel.

19. The oscillation control device according to claim 1, wherein
the inertial mass is a weight block with a beam.

20. The oscillation control device according to claim 1, wherein
the base body is a hull of a water vehicle, and wherein
the movable object is at least one of a cabin and a luggage compartment.
